(19) United States
(12) Patent Application Publication
(10) Pub. No.: US 2009/0009348 A1
(43) Pub. Date: Jan. 8, 2009

(54) PHOTOELECTRIC SMOKE SENSOR AND ELECTRONIC EQUIPMENT

(76) Inventor: Kazuhiro Mizuo, Kashihara-shi (JP)

Correspondence Address: NIXON & VANDERHYE, PC, 901 NORTH GLEBE ROAD, 11TH FLOOR, ARLINGTON, VA, 22203, US

(21) Appl. No.: 12/167,529

(22) Filed: Jul. 3, 2008

(30) Foreign Application Priority Data
Jul. 5, 2007 (JP) P2007-177195

(51) Int. Cl. G08B 17/107

(52) U.S. Cl. 340/630

(57) ABSTRACT

In a photoelectric smoke sensor, a casing has a bottom cover section in which a plurality of holes are formed. The bottom cover section having the holes has a function of allowing smoke to flow into and out of a smoke detecting section and preventing insects from entering the smoke detecting section from outside of the smoke detecting section. Thus, smoke is smoothly introduced from the lower side of the smoke detecting section into the smoke detecting section and there is no necessity of installing a large insect screen at the entrance of smoke flowing from the outside.

This nonprovisional application claims priority under 35 U.S.C. §119(a) on Patent Application No. 2007-177195 filed in Japan on Jul. 5, 2007, the entire contents of which are hereby incorporated by reference.

### BACKGROUND OF THE INVENTION

1. Technical Field

The present invention relates to a photoelectric smoke sensor having a precision smoke detectability and a small size.

2. Background Art

Conventional photoelectric sensors for detecting smoke, dust, or the like include reflection sensors, transmission sensors, and the like using an infrared LED and a silicon photodiode.

In these photoelectric sensors, various measures for effectively removing disturbed light and stray light are taken in connection with the arrangement of a light-receiving element and a light-emitting element and the inner structure of a casing.

For example, in a smoke sensor disclosed in JP 2004-220155 A, an elevation angle is given to the optical axes of the light-emitting device and the light-receiving device to prevent influence of reflected light from a lower part of a casing near the light-emitting device and the light-receiving device to thereby reduce the disturbed light incident to the light-receiving device. In addition to this, the smoke sensor has a light-trap structure with triangular protrusions in order to reduce the reflected light from an upper part of the casing.

However, giving an elevation angle to the optical axes would increase the thickness of the smoke sensor as a whole.

In addition, in the smoke sensor, the optical axes are given an elevation angle by bending the leads of a leaded light-receiving device and of a leaded light-emitting device. Thus, it is difficult to use a light-receiving device and a light-emitting device of surface mount type and thereby the miniaturization of the smoke sensor is inhibited.

An optical system which adopts a photoelectric sensor utilizing diffused and reflected light and allows the optical axes to point obliquely upward like the conventional smoke sensor has a problem that if a part of the casing is present in front of the light-emitting device, the reflection of light in the casing is large and there is a lot of stray light accordingly. In order to obviate this disadvantage, the inside of the casing should be widened, which, however, would result in an increased size of the smoke sensor.

In other words, if the reflection of light in the casing is not reduced, it follows that disturbed light other than the diffused and reflected light from smoke and/or internal reflected light enters the light-receiving device, and thereby not only the smoke detection accuracy of the smoke sensor is reduced, but also does the smoke sensor become susceptible to a change in the ambient environment such as a temperature change or a change in the disturbed light. Furthermore, using optics such as prism lenses and/or upsizing the casing increases the cost.

Furthermore, if the conventional photoelectric smoke sensor is provided with an insect screen, the sensor may also have an increased size.

### SUMMARY OF THE INVENTION

it is therefore an object of the present invention to provide a photoelectric smoke sensor which can be reduced in size, number of parts, and cost and can be increased in accuracy.

A photoelectric smoke sensor according to an aspect of the present invention includes:

a casing having a smoke detecting section into which smoke is introduced and a labyrinth section located around the smoke detecting section to block light traveling from outside of the smoke detecting section toward the smoke detecting section while allowing smoke to flow from outside of the smoke detecting section into the smoke detecting section;

a light-emitting section emitting light to the smoke detecting section; and

a light-receiving section receiving scattered light scattered by smoke in the smoke detecting section,

wherein the casing has a bottom cover section in which a plurality of holes are formed, the holes preventing insects from entering the smoke detecting section from outside while allowing smoke to flow into and out of the smoke detecting section.

In the photoelectric smoke sensor of this invention, smoke is allowed to flow into the smoke detecting section from the lower side of the bottom cover section through the holes formed in the bottom cover section and flow out of the smoke detecting section, and the bottom cover section prevents insects from entering into the smoke detecting section from the lower side of the smoke detecting section. Thus, according to this invention, no large insect screen is provided at the entrance of smoke flowing from the outside and smoke is smoothly introduced from the lower side of the smoke detecting section into the smoke detecting section, and thereby the smoke sensor can be reduced in size, thickness, number of parts, and cost.

In one embodiment, the bottom cover section, the smoke detecting section, and the labyrinth section of the casing are integrally molded.

In this embodiment, the casing is made in one piece by integrally molding the bottom cover section which can be used as an insect screen, the smoke detecting section, and the labyrinth section, so that the smoke sensor can be further reduced in size, number of parts, and cost.

In one embodiment, the casing has a plurality of protrusion sections, said protrusion sections each protruding into the smoke detecting section and having an acute angled tip.

In the photoelectric smoke sensor of this embodiment, the protrusion sections are able to reduce reflected light (stray light) in the smoke detecting section. Furthermore, it becomes unnecessary to provide two or more large reflector plates as stray light countermeasures in the smoke detecting section, so that it is avoided that smoke is inhibited from flowing into and out of the smoke detecting section by the existence of the reflector plates. Furthermore, the smoke sensor can be reduced in thickness as compared with the case that the height of the casing is increased to reduce the intensity of reflected light.

In one embodiment, at least one of the protrusion sections has two branch tips.

In the photoelectric smoke sensor of this embodiment, a crevice between the two branch tips of the protrusion section acts as a light trap to prevent stray light from being reflected by the tips of the protrusion section and entering the light-receiving section.

In one embodiment, at least one of the protrusion sections crosses a straight line connecting the light-emitting section with the light-receiving section and extends from the bottom cover section of the casing to a top end of the casing.

In the photoelectric smoke sensor of this embodiment, a protrusion section crossing the straight line connecting the light-emitting diode with the photodiode is able to prevent light emitted from the light-emitting section from directly striking the light-receiving section. Furthermore, the protrusion section extends from the bottom cover section of the casing to the top end of the casing, thereby surely preventing light emitted from the light-emitting section from directly striking the light-receiving section. In this connection, it is preferable that the protrusion section is a protrusion section that is the nearest to the light-emitting section of all the protrusion sections. In this case, light emitted from the light-emitting section is surely prevented from directly striking the light-receiving section.

In one embodiment, at least one of the protrusion sections does not cross a straight line connecting the light-emitting section with the light-receiving section and extends from the bottom cover section of the casing to a level of a top end of the light-emitting section, and the top end of the light-emitting section is nearer to the bottom cover section than the top end of the casing is.

According to the photoelectric smoke sensor of this embodiment, a protrusion section which does not cross the straight line connecting the light-emitting section with the light-receiving section extends to the level of the top end of the light-emitting section nearer to the bottom cover section than the top end of the casing, thereby reducing stray light without hindering smoke from flowing into and out of the smoke detecting section.

In one embodiment, the protrusion sections protrude into the smoke detecting section by dimensions which are not larger than dimensions to reach a half width region of a beam emitted by the light-emitting section.

In the photoelectric smoke sensor of this embodiment, a necessary smoke detection region in the smoke detecting section is ensured and it is suppressed that the light-emitting section emits light to a unnecessarily wide region and thereby stray light is generated.

In one embodiment, the protrusion sections protrude into the smoke detecting section by dimensions which are not larger than dimensions to reach a half width region in a light-receiving visual field of the light-receiving section.

In the photoelectric smoke sensor of this embodiment, a necessary smoke detection region in the smoke detecting section is ensured while preventing stray light from entering the light-receiving section.

In one embodiment, the casing has a light-blocking protrusion located in front of the light-receiving section to prevent reflected light from the protrusion sections and/or the inner wall of the smoke detecting section from entering the light-receiving section.

In the photoelectric smoke sensor of this embodiment, the light-blocking protrusion is able to prevent stray light from entering the light-receiving section.

In this connection, it is preferable that the light-blocking protrusion is located near the light-receiving section and has a length not more than a length to reach the half width region in the visual field of the light-receiving section to ensure a necessary smoke detection region in the smoke detecting section. Furthermore, it is preferable that the tip of the light-blocking protrusion is sharply pointed to have an angle of about 45 degrees or less. Light which has struck an inner inside of the light-blocking protrusion is prevented from entering the light-receiving section by a light trap effect, and reflected light from other protrusions is allowed to strike an outer side of the light-blocking protrusion and is blocked by it, so that the stray light can be reduced.

Electronic equipment according to an embodiment of the present invention has the photoelectric smoke sensor, thereby being reduced in size, number of parts, and cost. An example of the electronic equipment is lighting equipment, an air conditioner or the like.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1A is a plan view of a casing 1 of an embodiment of the photoelectric smoke sensor according to the present invention;

FIG. 1B is a side view of the casing 1;

FIG. 1C is a bottom view of the casing 1;

FIG. 2 is an exploded view of the embodiment;

FIG. 3 shows an outer appearance of the embodiment;

FIG. 4 is a schematic view depicting a smoke detection operation of the embodiment;

FIG. 5 is a partially enlarged schematic plan view showing the state of the neighborhood of the smoke detecting section 12 of the casing of the embodiment; and

FIG. 6 is a cross-sectional view of the casing of the embodiment.

### DETAILED DESCRIPTION OF THE INVENTION

The present invention will be described in detail below with reference to an embodiment shown in the figures.

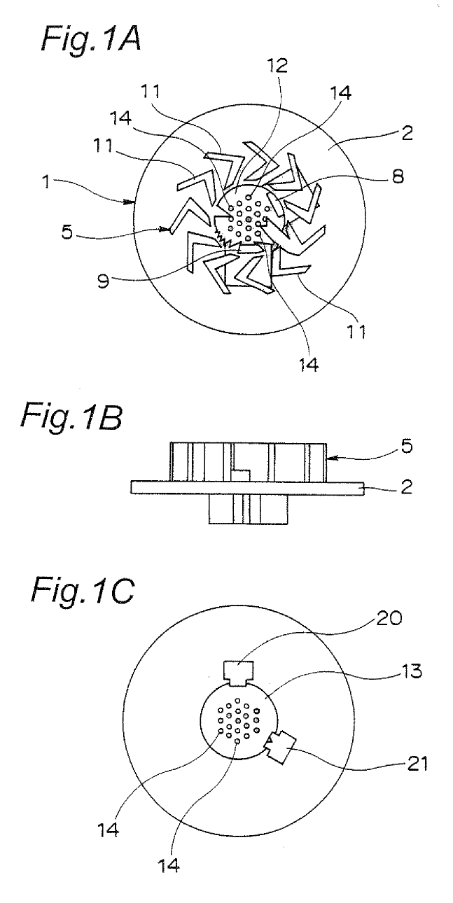

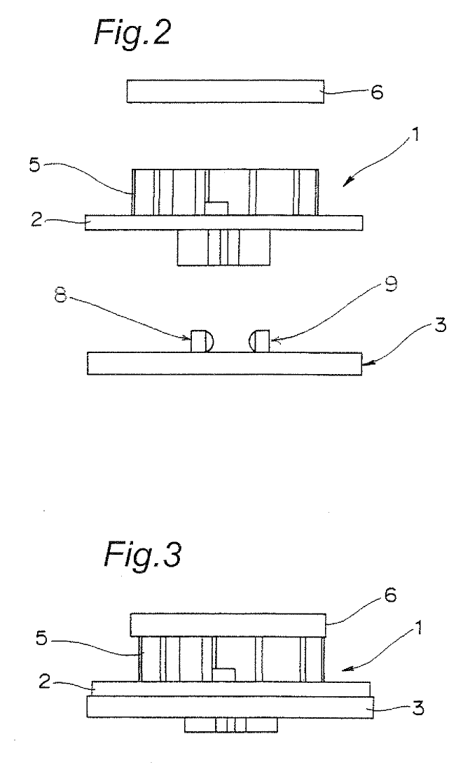

FIG. 1A shows a casing 1 of an embodiment of the photoelectric smoke sensor according to the present invention as viewed downward from above, FIG. 1B shows the casing 1 as viewed from a lateral side thereof, and FIG. 1C shows the casing 1 as viewed upward from below. Furthermore, FIG. 2 is an exploded view of the photoelectric smoke sensor of this embodiment, and FIG. 3 is an external view showing a state viewed from one side of the photoelectric smoke sensor of this embodiment.

As shown in FIGS. 2 and 3, this embodiment has a casing 1, a printed wiring board 3 attached to the underside of a flange section 2 of the casing 1, and a resin cover 6 attached to a labyrinth section 5 of the casing 1 from above. Mounted on the printed wiring board 3 are a light-emitting diode 8 which is a light-emitting section, a photodiode 9 which is a light-receiving section, and other electrical and/or electronic components (not shown). In FIG. 1C, the reference numeral 20 denotes a light-emitting device cover covering the light-emitting diode 8, and the reference numeral 21 denotes a light-receiving device cover covering the photodiode 9. The light-emitting diode 8 and the photodiode 9 are mounted on the printed wiring board 3 by soldering and then inserted in the light-emitting device cover 20 and the light-receiving device cover 21. The casing 1, the resin cover 6, and the printed wiring board 3 are assembled into a photoelectric smoke sensor shown in FIG. 3.

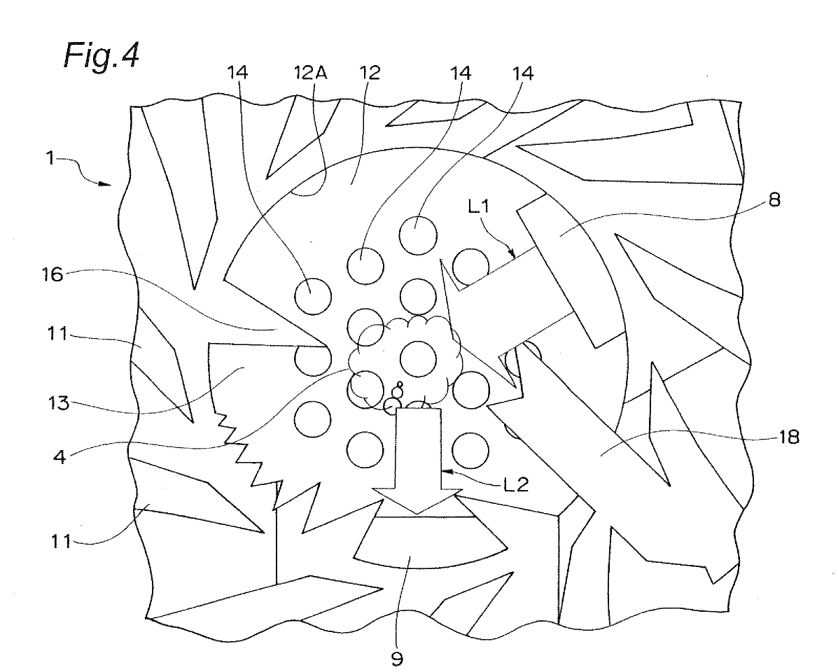

As shown in FIG. 1A, the labyrinth section 5 is formed on the flange section 2 of the casing 1. The labyrinth section 5 has a plurality of portions 11 bent like the letter V, which are formed at a predetermined interval in a circumferential direction. There is a smoke detecting section 12 inside the labyrinth section 5. The labyrinth section 5 blocks light traveling from outside of the smoke detecting section 12 toward the smoke detecting section 12 but allows smoke to flow from the outside of the smoke detecting section 12 into the smoke detecting section 12. Furthermore, as shown in FIG. 4, the is light-emitting diode 8 and the photodiode 9 are located in the smoke detecting section 12 of the casing 1, and the light-emitting diode 8 emits light L1 inwardly of the smoke detecting section 12 and the photodiode 9 receives scattered light L2 scattered by particles of smoke 4 in the smoke detecting section 12 to thereby detect the smoke.

Furthermore, as shown in FIGS. 1C and 4, the casing 1 has a bottom cover section 13 in which a plurality of holes 14 are formed. The bottom cover section 13 in which the holes 14 are formed has a function of allowing smoke to flow into and out of the smoke detecting section 12 and preventing insects from entering the smoke detecting section 12 from outside of the smoke detecting section 12. Thus, according to this embodiment, smoke can be smoothly introduced from the lower side of the smoke detecting section 12 into the smoke detecting section 12 without installing a large insect screen at the entrance of smoke flowing from the outside, and thereby the smoke sensor can be reduced in size, thickness, number of parts, and cost. Furthermore, the holes 14 of the bottom cover section 13 and the labyrinth section 5 provide smoke flow paths through which smoke efficiently flows.

Furthermore, in this embodiment, the bottom cover section 13 which can be used as an insect screen, the smoke detecting section 12, and the labyrinth section 5 are integrally molded. Thus, the casing 1 is made in one piece, so that the smoke sensor can be further reduced in size, thickness, number of parts, and cost.

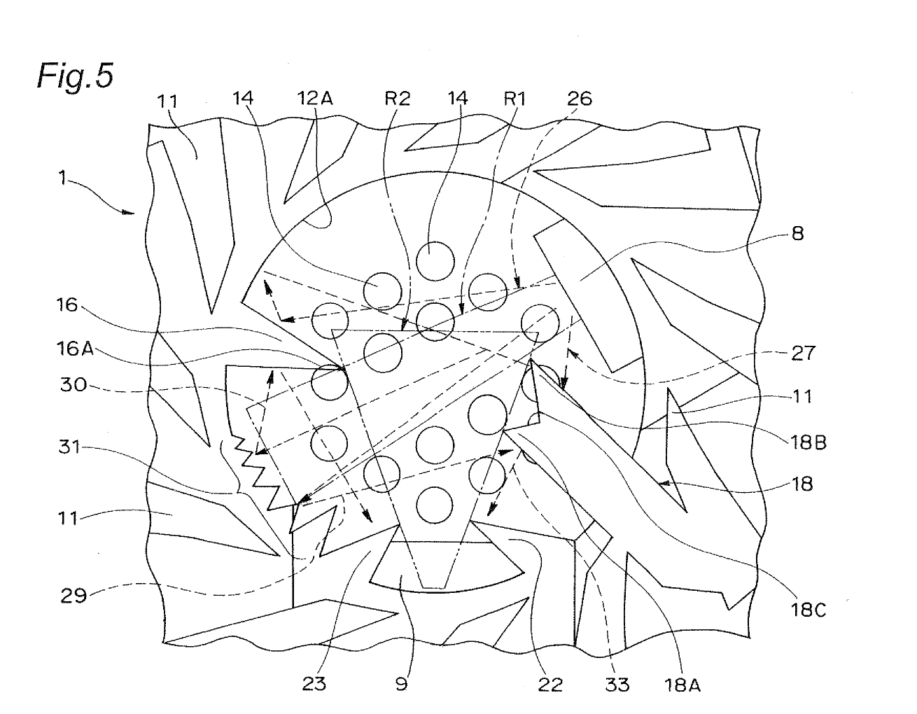

Furthermore, in this embodiment, the casing 1 has protrusion sections 16 and 18 protruding into the smoke detecting section 12 as shown in FIG. 5. The protrusion section 16 protrudes from the inner wall 12A of the smoke detecting section 12 and is tapered, the tip 16A of which is an acute angled tip. Furthermore, the protrusion section 18 has two branch tips 18A and 18B which are pointed to have acute angles. In addition, the casing 1 has a protrusion group 31 consisting of a plurality of protrusions which protrude from the inner wall 12A of the smoke detecting section 12 and the tips of which are pointed to have respective acute angles. The nearer to the photodiode the protrusions of the protrusion group 31 are, the larger protrusion dimensions the protrusions have.

The two protrusion sections 16 and 18 are able to block light 26, 27 causing stray light to prevent the light 26, 27 from becoming stray light and reduce reflected light (stray light) in the smoke detecting section 12, so that the accuracy of smoke detection is increased. Furthermore, it becomes unnecessary to provide two or more large reflector plates as stray light countermeasures in the smoke detecting section 12, so that it is avoided that smoke is inhibited from flowing into and out of the smoke detecting section by the existence of the reflector plates. Furthermore, the smoke sensor is made smaller in thickness as compared with the case that the height of the casing is increased to reduce the intensity of reflected light.

Furthermore, a crevice 18C between the two branch tips 18A and 18B of the protrusion section 13 acts as a light trap to prevent stray light 26 from being reflected by the tips of the protrusion section 18 and entering the photodiode 9 which is a light-receiving section.

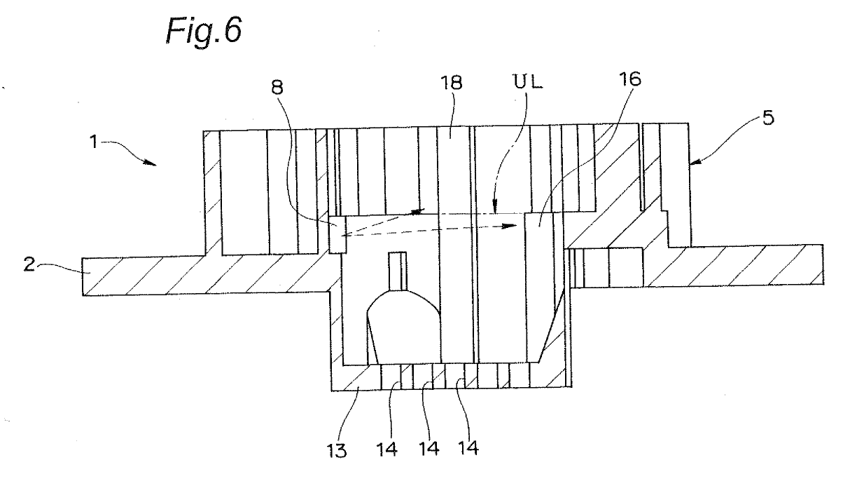

Furthermore, in this embodiment, the protrusion section 18 crosses a straight line connecting the light-emitting diode 8 with the photodiode 9 as shown in FIG. 5, thereby preventing light emitted from the light-emitting diode 8 from directly striking the photodiode 9. Furthermore, as shown in FIG. 6, the protrusion section 18 extends from the bottom cover section 13 of the casing 1 to the top end of the casing 1, thereby more surely preventing light emitted from the light-emitting diode 8 from directly striking the photodiode 9 as a light-receiving section. In addition, in this embodiment, the protrusion section 18 is nearer to the light-emitting diode 8 than the protrusion section 16, thereby surely preventing light emitted from the light-emitting diode 8 from directly striking the photodiode 9. In other words, the protrusion section 18 is useful for not only reducing stray light but also preventing light emitted from the light-emitting diode 8 from directly entering the photodiode 9. Since light traveling straight directly from the light-emitting diode 8 to the photodiode 9 has a higher intensity than stray light caused by reflection, the protrusion section 18 is extended from the bottom cover section 13 of the casing 1 to the top end of the casing 1, thereby surely preventing light emitted from the light-emitting diode 8 from passing through the upper side or lower side of the protrusion section 18 and directly entering the photodiode 9.

Furthermore, in this embodiment, the protrusion section 18 is integrated with a bent portion 11 shaped like the letter V of the labyrinth section 5 and protrudes from the V-shaped bent portion 11 into the smoke detecting section 12

Furthermore, in this embodiment, the two protrusion sections 16 and 18 protrude into the smoke detecting section 12 by dimensions to reach a half width region R1 of a beam emitted by the light-emitting diode 8. Thus, a necessary smoke detection region in the smoke detecting section 12 is ensured and it is avoided that the light-emitting diode 8 emits light to an unnecessarily wide region and thereby stray light is generated. Furthermore, in this embodiment, the two protrusion sections 16 and is protrude into the smoke detecting section 12 by dimensions to reach the half width region R2 in the light-receiving visual field of the photodiode 9, thereby preventing stray light from entering the photodiode 9 while ensuring a necessary smoke detection region in the smoke detecting section 12.

Furthermore, the protrusion section 16, which does not cross a straight line connecting the light-emitting diode 8 with the photodiode 9, extends, as shown in FIG. 6, from the bottom cover section 13 to a height or level UL of the top end of the light-emitting diode 8, which is nearer to the bottom cover section 13 than the top end of the casing 1 is. Thus, the protrusion section 16 is able to reduce stray light without hindering smoke from flowing into and out of the smoke detecting section 12, Furthermore, each of the protrusions of the protrusion group 31 shown in FIG. 5 also extends from the bottom cover section 13 to the level UL of the top end of the light-emitting diode 8.

Furthermore, in this embodiment, the casing 1 has, as shown in FIG. 5, light-blocking protrusions 22 and 23 positioned in front of the photodiode 9. The light-blocking protrusions 22 and 23 also extend from the bottom cover section 13 to the level UL of the top end of the light-emitting diode 8. Thus, the light-blocking protrusions 22 and 23 are able to prevent reflected light (stray light) reflected from at least one of the protrusion sections 16 and 18, at least one of the protrusions in the protrusion group 31, and/or the inner wall 12A of the smoke detecting section 12 from entering the photodiode 9 without blocking the flow of smoke.

Furthermore, the light-blocking protrusions 22 and 23, the protrusion sections 16 and 18, and the protrusions of the protrusion group 31 are able to block the light 29, 30, and 33 that are not light to be detected reflected by smoke, thereby reducing stray light and increasing the detection accuracy.

Furthermore, the light-blocking protrusions 22 and 23 are located near the photodiode 9 which is a light-receiving section and have lengths not larger than lengths to reach the half width region of the visual field of the photodiode 9 to ensure a necessary smoke detection region in the smoke detecting section 12. It is preferable that the tips of the light-blocking protrusions 22 and 23 are sharply pointed to have an angle of about 45 degrees or less. Due to this arrangement and shapes of the light-blocking protrusions 22 and 23, it becomes easy to prevent light which has struck the insides of the light-blocking protrusions 22 and 23 from entering the photodiode 9 by a light trap effect. In addition, light reflected from the protrusion sections 16 and 18, which will strike the light-blocking protrusions 22 and 23 on the outer side, is thus blocked. As a result, the stray light is reduced.

In this embodiment, two protrusion sections 16 and 18 are provided, but more than two protrusion sections may be provided. However, an excess of protrusion sections would hinder the flow of smoke. Therefore, the casing should preferably be configured so as to be able to block light efficiently with a minimum number of protrusion sections.

Furthermore, in this embodiment, the protrusion dimensions of the two protrusion sections 16 and 18 are equal to dimensions to reach the half width region R1 of a beam emitted by the light-emitting diode 8, but may be less than such dimensions. Furthermore, in this embodiment, the protrusion dimensions of the two protrusion sections 16 and 18 are equal to dimensions to reach the half width region R2 of the light-receiving visual region of the photodiode 9, but may be less than such dimensions. Electronic equipment such as lighting equipment and air conditioners provided with the photoelectric smoke sensor of this embodiment can be reduced in size, number of parts, and cost.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A photoelectric smoke sensor comprising:
a casing having a smoke detecting section into which smoke is introduced and a labyrinth section located around the smoke detecting section to block light traveling from outside of the smoke detecting section toward the smoke detecting section while allowing smoke to flow from outside of the smoke detecting section into the smoke detecting section;
a light-emitting section emitting light to the smoke detecting section; and
a light-receiving section receiving scattered light scattered by smoke in the smoke detecting section,
wherein the casing has a bottom cover section in which a plurality of holes are formed, the holes preventing insects from entering the smoke detecting section from outside while allowing smoke to flow into and out of the smoke detecting section.

2. A photoelectric smoke sensor as claimed in claim 1, wherein the bottom cover section, the smoke detecting section, and the labyrinth section of the casing are integrally molded.

3. A photoelectric smoke sensor as claimed in claim 1, wherein the casing has a plurality of protrusion sections, said protrusion sections each protruding into the smoke detecting section and having an acute angled tip.

4. A photoelectric smoke sensor as claimed in claim 3, wherein at least one of the protrusion sections has two branch tips.

5. A photoelectric smoke sensor as claimed in claim 3, wherein at least one of the protrusion sections crosses a straight line connecting the light-emitting section with the light-receiving section and extends from the bottom cover section of the casing to a top end of the casing.

6. A photoelectric smoke sensor as claimed in claim 3, wherein:
at least one of the protrusion sections does not cross a straight line connecting the light-emitting section with the light-receiving section and extends from the bottom cover section of the casing to a level of a top end of the light-emitting section; and
the top end of the light-emitting section is nearer to the bottom cover section than the top end of the casing is.

7. A photoelectric smoke sensor as claimed in claim 3, wherein the protrusion sections protrude into the smoke detecting section by dimensions which are not larger than dimensions to reach a half width region of a beam emitted by the light-emitting section.

8. A photoelectric smoke sensor as claimed in claim 3, wherein the protrusion sections protrude into the smoke detecting section by dimensions which are not larger than dimensions to reach a half width region in a light-receiving visual field of the light-receiving section.

9. A photoelectric smoke sensor as claimed in claim 3, wherein the casing has a light-blocking protrusion located in front of the light-receiving section to prevent reflected light from the protrusion sections and/or the inner wall of the smoke detecting section from entering the light-receiving section.

10. Electronic equipment comprising a photoelectric smoke sensor according to claim 1.
